(19) United States
(12) Patent Application Publication
(10) Pub. No.: US 2017/0131213 A1
(43) Pub. Date: May 11, 2017

(54) URINE BOWEL APPARATUS AND METHOD FOR MAKING THE SAME

(71) Applicant: Aminata Cisse, New York, NY (US)

(72) Inventor: Aminata Cisse, New York, NY (US)

(21) Appl. No.: 15/281,556

(22) Filed: Sep. 30, 2016

Related U.S. Application Data
(60) Provisional application No. 62/235,002, filed on Sep. 30, 2015.

(51) Int. Cl. G01N 21/78

(52) U.S. Cl. CPC G01N 21/78; G01N 2021/7759

(57) ABSTRACT

An apparatus for urine sample collection and testing is provided. The apparatus has at least one chamber for receiving the urine sample. The chamber has a test component used to analyze one or more parameters of a urine sample. The chamber may have a plurality of compartment, with each compartment having a test component used to analyze a plurality of parameters of multiple urine samples. The test component may have a color change indicative of various characteristics of a parameter. The apparatus also provides a color scale with a plurality of reference colors for use in comparing with the color change produced in the analyzed urine sample.

### CROSS-REFERENCE TO RELATED APPLICATION

The present application is related to and claims priority from prior provisional application Ser. No. 62/235,002, filed Sep. 30, 2016 which application is incorporated herein by reference.

### FIELD OF THE INVENTION

The present invention generally relates to an apparatus and method for making the same and method for collecting urine and analyzing the urine.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

Test strips are commonly used to detect a parameter in a urine sample. The test strip has a sample pad where a urine sample can be deposited. The test strip further has a reagent pad having a reagent in a reaction zone. The urine sample deposited on the sample pad moves to the reaction pad and a reaction happens between the urine sample and reagent. The reaction can be a colorimetric reaction i.e. a reaction generating change of color. The test strip with change of color is then positioned near a color scale and the color developed on the reagent pad is matched with the colors shown on the color scale to identify the substantially identical color on the color scale. The identified color on the color scale helps to determine the quality of the parameter in question in the urine sample. Such parameter includes for example, pH of the urine, glucose level in the urine, and the presence of certain microbes in the urine.

To conduct the analysis of a urine sample with the test strip, doctor, nurse, technician or tester has to handle the urine sample. Urine tends to fall on the handling person. Also, the person has to bear the smell of urine. Due to these and other hygienic reasons, the handling of urine sample and conducting its analysis with a test strip is generally undesirable. Therefore it is desirable to reduce the amount of handling needed to conduct analysis of urine sample. Some attempts have been made at providing solution for this issue. However, those attempts still require testing personnel to handle urine samples to some extent. Hence it is desired that an apparatus is provided which completely eradicates the need of handling of urine samples by a doctor, nurse, lab technician or testing person. It is yet further desirable that apparatus and method is easy to use. Furthermore, it is desired that the method is reliable and provides accurate results for various parameters tested in a urine sample.

### BRIEF SUMMARY OF THE INVENTION

In view of the foregoing, one aspect of the various disclosed embodiments in the present invention is to provide an apparatus for urine sample collection and testing, and a method of urine sample with the apparatus for urine sample collection and testing.

In one aspect, an apparatus for urine sample collection and testing is provided. The apparatus has at least one chamber. The chamber has a test component. The apparatus also has a color scale having a plurality of reference colors for comparison with the color change, where one of the plurality of reference colors represent a normal value. The apparatus also includes a top portion having an opening where the opening is configured to receive the urine sample and direct the urine sample to the at least one chamber for analysis. The apparatus further has a lid for closing the opening.

In another aspect, a method for making an apparatus for urine sample collection and testing is provided. The method includes providing at least one chamber having a top portion, the top portion has an opening and the opening is configured to receive a urine sample and direct the urine sample into the at least one chamber for analysis. The method includes coupling a test component within and onto the at least one chamber. The method also includes coupling a color scale having a plurality of reference colors for comparison with the color change to the at least one chamber, where one of the plurality of reference colors represents a normal value. The method further includes providing a lid for closing the opening.

In yet another aspect, a method for making an apparatus for urine sample collection and testing is provided. The method includes providing at least one chamber having a top portion, the top portion having an opening configured to receive a urine sample and direct the urine sample into the at least one chamber for analysis. The method includes providing a plurality of compartments within said at least one chamber and coupling a test component within and onto each said plurality of compartments. The method also includes coupling a color scale having a plurality of reference colors for comparison with the color change to said at least one chamber, where one of the plurality of reference colors represents a normal value. The method further includes providing a lid for closing the opening.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 shows a perspective view of an apparatus for urine sample collection and testing, in accordance with embodiments of the present invention.

FIG. 2 shows a perspective view of an apparatus for urine sample collection and testing, in accordance with embodiments of the present invention.

FIG. 3 shows a perspective view of an apparatus for urine sample collection and testing, in accordance with embodiments of the present invention.

FIG. 4 illustrates a method, in accordance with embodiments of the present invention.

FIG. 5 illustrates a method, in accordance with embodiments of the present invention.

### DETAILED DESCRIPTION

The following detailed description of the present invention is enabling teaching of the invention and its best, currently known embodiment. Those skilled in the art can understand that many changes can be made in the embodiments described, while still obtaining beneficial results of the present invention. It will also be apparent that some of the desired benefits of the present invention can be obtained by selecting some of the features of the invention while not utilizing other features. Accordingly, those working in the relevant art will recognize that many adaptations and modification to the present invention can be made and may be desired in certain circumstances, and are part of the present invention. Thus, the following description is provided as illustrative of the principle of the present invention.

Embodiments of the present invention provide an apparatus for urine sample collection and testing which can be used by a patient to collect his/her urine sample and simultaneously have the collected urine sample analyzed automatically in the same apparatus. Accordingly, the specific embodiments discussed herein are merely illustrative of specific manners in which to make and use this invention, and are not intended to represent an exhaustive list of all possible structure and processes of the present invention.

Aspects of the present invention provide for an apparatus for collecting a urine sample. The apparatus has a top portion and an opposite bottom portion. Approximate the top portion is an opening. The opening can be closed with a lid. In some aspects, the apparatus has one chamber within the apparatus. The opening allows a urine sample to be directed into the chamber. Within the chamber is a testing component. In other aspects, the apparatus has a chamber that has one or more compartments. Each compartment is configured to retain each urine sample such that the urine sample in a first compartment does not touch or contaminate a urine sample in a second compartment. Each compartment has a testing component. The testing component is configured for analyzing a urine sample by detecting and analyzing one or more parameters of the urine sample. In some aspects the testing component is a test strip. The test strip may contain one or more chemical reagents for reacting with the content of the urine sample to generate a color change of the analyzed urine sample.

In some aspects, a color scale is provided on the apparatus for comparison of the color to indicate the quality of the parameters detected in the urine sample. The color scale has a plurality of reference colors to indicate, among other things, the quality of the parameter detected in the urine sample. One reference color of the plurality of reference colors represents a normal value of the detected parameter. A normal value may be considered a healthy value. For instance, if a urine sample is being tested for a myriad of types of urinary tract infection related bacteria, then the normal value would be considered a value corresponding to urine that does not contain any type of urinary tract infection bacteria. A normal value may also be considered a designated value. For instance, if a urine sample is being tested for a specific type of urinary tract infection bacteria, then the normal value would be considered a value corresponding to that specific type of urinary tract infection bacteria.

The parameters analyzed may include, but are not limited to, infection, glucose, ketone bodies, blood protein, specific gravity, pH, leukocyte, hemoglobin, nitrate, nitrite, protein, urobilinogen, bilirubin, hypertension, diabetes, hemolysis, liver disease, and severe diarrhea.

Embodiments of the apparatus and method of using it are shown in the figures, and discussed below. While the structure and processes have been described with a certain degree of particularity, it is to be noted that many modifications may be made in the details of the structure and processes without departing from the spirit and scope of this disclosure. It is understood that the structure and processes are not limited to the embodiments set forth herein for purposes of exemplification.

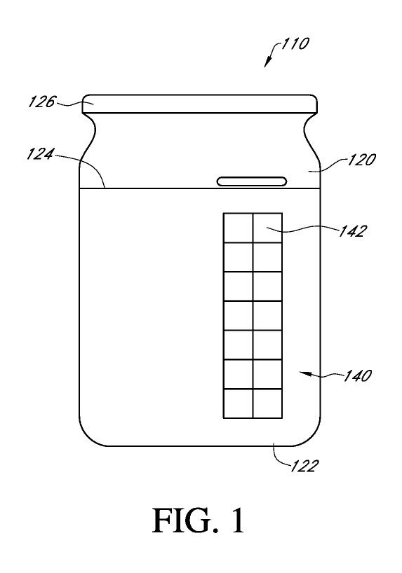

Turning now to FIG. 1, a perspective view of the present invention, the present invention providing an apparatus 110 for urine sample collection and testing. As shown in FIG. 1, apparatus 110 is bottle shaped. However, in further embodiments, apparatus 110 can be cylindrical, rectangular, square, or any other shape. Apparatus 110 has a top portion 120 and an opposite bottom portion 122. An opening 124 is located at top portion 120. Opening 124 can be closed with a lid 126. Attached to the exterior of apparatus 110 is a color scale 140 having a plurality of reference colors 142. Apparatus 110 has a chamber (not shown). The chamber has a test component (not shown) for analyzing one or more parameters of a urine sample.

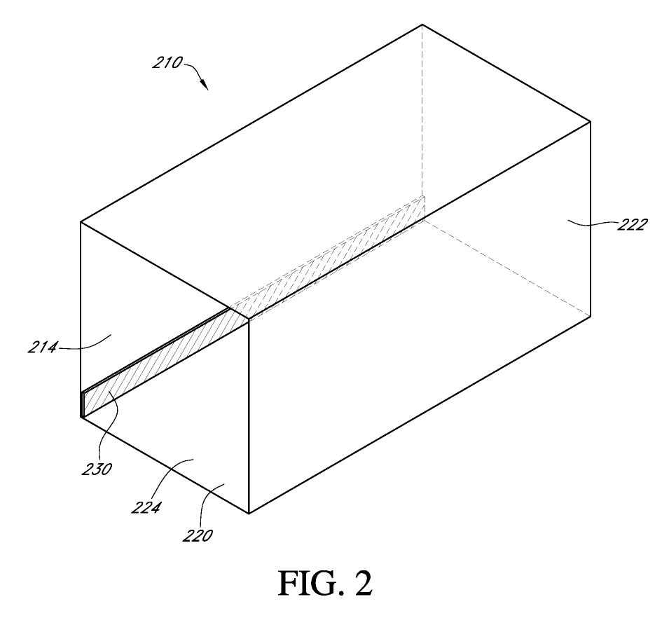

FIG. 2 shows a perspective view of apparatus 210. Apparatus 210 is similar to apparatus 110 and allows for the collection and testing of urine samples. Apparatus 210 is shaped as a rectangle. However, apparatus can be cylindrical, bottle shaped, square, or any other shape. Apparatus 210 has a top portion 220 and an opposite bottom portion 222. An opening 224 is located at top portion 220. Opening 224 can be closed with a lid (not shown). Attached to the exterior of apparatus 210 is a color scale (not shown). Apparatus 210 has a chamber 214. Chamber 214 has a test component 230 for analyzing the urine sample.

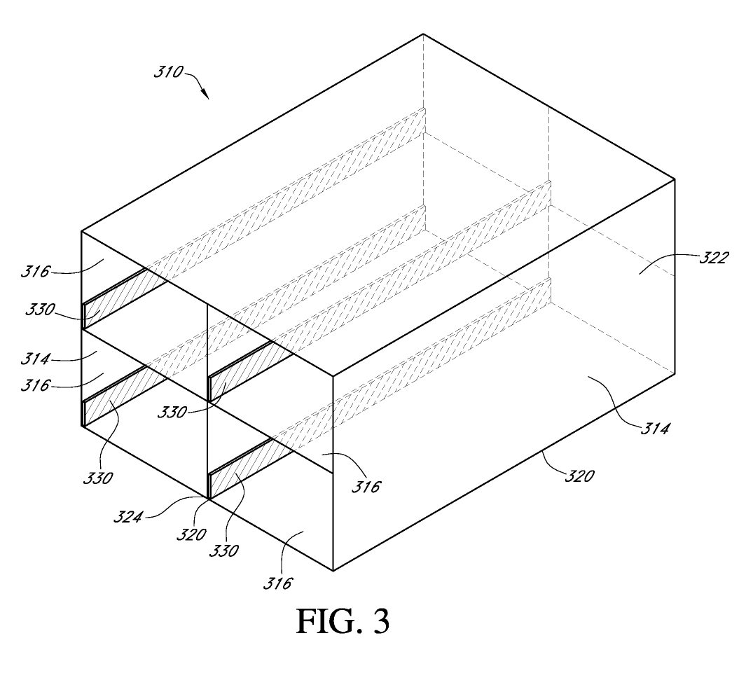

FIG. 3 shows a perspective view of apparatus 310. Apparatus 310 is similar to apparatus 110 and apparatus 210 and allows for the collection and testing of urine samples. Apparatus 310 is shaped as a rectangle. However, apparatus can be cylindrical, bottle shaped, square, or any other shape. Apparatus 310 has a top portion 320 and an opposite bottom portion 322. An opening 324 is located at top portion 320. Opening 324 can be closed with a lid (not shown). Attached to the exterior of apparatus 310 is a color scale (not shown). In some embodiments, apparatus 310 has a chamber 314. Chamber 314 contains a plurality of compartments 316 that collect urine samples. Each compartment 316 has a test component 330 for analyzing the urine sample.

The urine sample of the test subject is directly collected in the apparatus. The test subject or patient himself/herself collects the sample in the apparatus. In certain aspects, the volume of urine required is 4 ml-5 ml. In additional aspects, the urine sample collected can be retained in the container for 5 minutes.

The apparatus is capable of automatically performing analysis in a highly reliable manner. The apparatus provides results with the greater than 90% accuracy. The analysis may be performed at room temperature, below room temperature, or above room temperature. The reaction of the urine sample with the test component during the analysis of the urine sample results in a color change on the apparatus. For each detected parameter, a distinct color is an indicator. This color change is reviewed against the reference color to identify the detected value of the parameter analyzed in the urine sample. In some aspects, the value can be read in 2 minutes.

The analysis performed on the urine sample includes chemical, qualitative and quantitative and semi-quantitative analysis. The parameters or conditions analyzed include but not limited to infection, glucose, ketone bodies, blood, protein, specific gravity, pH, leukocyte, hemoglobin, nitrate, nitrite, protein, urobilinogen, bilirubin, hypertension, diabetes, hemolysis, liver disease, severe diarrhea etc.

The apparatus is a single use kit. Once the test is completed on one urine sample, the apparatus is discarded. The apparatus is made from a light weight and sturdy material. It is preferred that the apparatus is made of plastic. The urine sample container and testing apparatus has a volume of 10 ml. In another embodiment of the present invention, the apparatus has a volume of 8 ml.

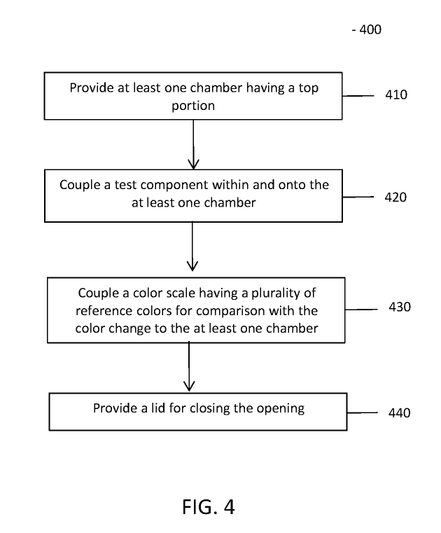

FIG. 4 illustrate a method 400 for making an apparatus for urine sample collection and testing. At step 410, at least one chamber having a top portion is provided. The top portion has an opening configured to receive a urine sample and direct the urine sample into the at least one chamber for analysis. At step 420 a test component is coupled within and onto the at least one chamber. At step 430, a color scale having a plurality of reference colors for comparison with the color change is coupled to the at least one chamber, where one of the plurality of reference colors represent a normal value. At step 440 a lid for closing the opening is provided.

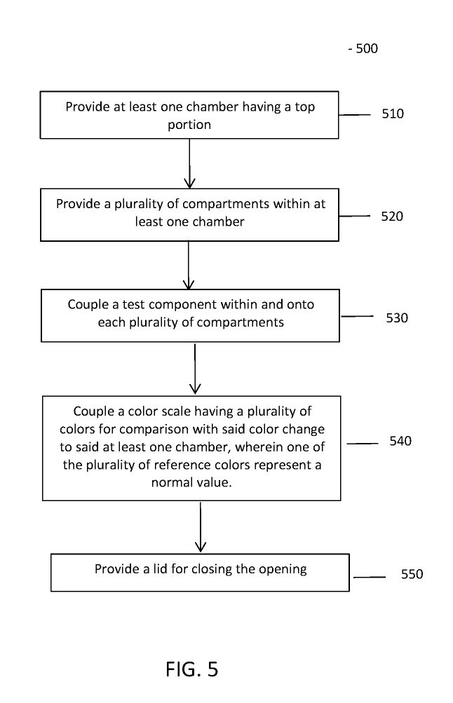

FIG. 5 illustrates a method 500 for making an apparatus for urine sample collection and testing. At step 510 at least one chamber having a top portion is provided. The top portion has an opening configured to receive a urine sample and direct the urine sample into the at least one chamber for analysis. At step 520, a plurality of compartments within the at least one chamber is provided. At step 530, a test component is coupled within and onto each plurality of compartments. At step 540, a color scale having a plurality of reference colors for comparison with the color change is coupled to the at least one chamber, where one of the plurality of reference colors represent a normal value. At step 550, a lid for closing the opening is provided.

It is to be understood that the above description is intended to be illustrative, and not restrictive. For example, the above discussed embodiments may be used in combination with each other. Many other embodiments will be apparent to those of skill in the art upon reviewing the above description.

Whereas, the construction and method have been described in relation to the figures of the drawings, it should be understood that other and further modifications, apart from those shown or suggested herein, may be made within the spirit and scope of this invention.

What is claimed:

1. An apparatus for urine sample collection and testing, the apparatus comprising:
at least one chamber;
a test component present in said at least one chamber,
a color scale having a plurality of reference colors for comparison with said color change, wherein one of the plurality of reference colors represent a normal value;
a top portion having an opening, the opening configured to receive the urine sample and direct the urine sample to said at least one chamber for analysis; and
a lid for closing the opening.

2. The apparatus of claim 1, wherein the apparatus is bottle shaped.

3. The apparatus of claim 1, wherein said test component is configured to analyze a urine sample for at least one parameter.

4. The apparatus of claim 1, wherein the apparatus is configured to detect multiple parameters.

5. The apparatus of claim 4, the at least one chamber has a plurality of compartments, each of said plurality of compartments has a test component configured to analyze the urine sample.

6. The apparatus of claim 1, wherein the test component is a test strip, said test strip including a chemical reagent, the chemical reagent configured to react with the urine sample to generate a color change.

7. The apparatus of claim 1, wherein the apparatus is made of plastic.

8. The apparatus of claim 1, wherein the parameter analyzed in the urine sample is selected from a list including infection, glucose, ketone bodies, blood protein, specific gravity, pH, leukocyte, hemoglobin, nitrate, nitrite, protein, urobilinogen, bilirubin, hypertension, diabetes, hemolysis, liver disease, and severe diarrhea.

9. The apparatus of claim 1, wherein the apparatus is a single use kit.

10. The apparatus of claim 1, wherein the volume of the apparatus is 10 ml.

11. The apparatus of claim 1, wherein the volume of the apparatus is 8 ml.

12. The apparatus of claim 1, wherein the volume of the urine sample is 5 ml.

13. The apparatus of claim 1, wherein the volume of the urine sample is 4 ml.

14. A method for making an apparatus for urine sample collection and testing, the method comprising:
providing at least one chamber having a top portion, said top portion having an opening, said opening configured to receive a urine sample and direct the urine sample into said at least one chamber for analysis;
coupling a test component within and onto said at least one chamber;
coupling a color scale having a plurality of reference colors for comparison with said color change to said at least one chamber, wherein one of the plurality of reference colors represent a normal value; and
providing a lid for closing the opening.

15. The method of claim 14, wherein said test component is configured to analyze the urine sample for at least one parameter.

16. The method of claim 14, wherein the test component is a test strip, said test strip including a chemical reagent, the chemical reagent configured to react with the urine sample to generate a color change.

17. The apparatus of claim 14, wherein the parameter analyzed in the urine sample is selected from a list including infection, glucose, ketone bodies, blood protein, specific gravity, pH, leukocyte, hemoglobin, nitrate, nitrite, protein, urobilinogen, bilirubin, hypertension, diabetes, hemolysis, liver disease, and severe diarrhea.

18. A method for making an apparatus for urine sample collection and testing, the method comprising:
providing at least one chamber having a top portion, said top portion having an opening, said opening configured to receive a urine sample and direct the urine sample into said at least one chamber for analysis;
providing a plurality of compartments within said at least one chamber;
coupling a test component within and onto each said plurality of compartments;
coupling a color scale having a plurality of reference colors for comparison with said color change to said at least one chamber, wherein one of the plurality of reference colors represent a normal value; and
providing a lid for closing the opening.

19. The method of claim 18, wherein said test component is configured to analyze the urine sample for at least one parameter.

20. The method of claim 19, wherein the test component is a test strip, said test strip including a chemical reagent, the chemical reagent configured to react with the urine sample to generate a color change.
